(19) United States
(12) Patent Application Publication
(10) Pub. No.: US 2026/0179308 A1
(43) Pub. Date: Jun. 25, 2026

(54) METHOD OF RENDERING A THREE-DIMENSIONAL REPRESENTATION OF AN OBJECT IN AN INTERNET BROWSER

(71) Applicant: THREEDIUM Ltd, London (GB)

(72) Inventors: Dusan ODOBASIC, Belgrade (RS); Igor KNEŽEVIC, Belgrade (RS)

(73) Assignee: THREEDIUM Ltd, London (GB)

(21) Appl. No.: 18/991,911

(22) Filed: Dec. 23, 2024

(51) Int. Cl. G06T 15/08; G06T 19/20

(52) U.S. Cl. CPC G06T 15/08; G06T 19/20; G06T 2210/62; G06T 2219/2016

(57) ABSTRACT

A method of rendering a three-dimensional representation of an object in an internet browser on a display device. The method includes receiving on a first computer device object model data defining features of an object, identifying substantially opaque and non-opaque parts of the object, and generating browser image data for sending to a browser to render images representing the object on a display device including opacity data identifying the substantially opaque and non-opaque parts. The browser image data is sent to a browser on a second computer device. The substantially opaque parts are rendered using rasterizing techniques from the browser image data and the substantially non-opaque parts are rendered using at least one of the volume rendering technique and the depth peeled screen space refraction technique from the browser image data. A first image representing the object at a first angle is displayed an internet browser on a display device.

### BACKGROUND OF THE INVENTION

The present invention relates to a method of rendering a three-dimensional representation of an object in an internet browser and relates particularly, but not exclusively, to a method of rendering images complex objects such as liquids in glass bottles.

The three-dimensional modelling of objects for display on computer devices is commonplace and it is becoming increasingly important. For example, online retailers want to be able to offer their customers a complete view of a product which they might purchase. Previously, three-dimensional modelling was only possible on a device with a powerful graphics processor, but it is becoming increasingly possible to display three-dimensional objects in an internet browser and allow a user to manipulate the object enabling them to view it from a chosen angle.

For simple opaque objects this process has been successfully utilised within internet browsers. However, more complicated objects, such as glass bottles containing liquids are more difficult to model due to the internal refraction of light taking place within such. Traditionally, where complex objects have been modelled, for example in computer games, the three-dimensional modelling technique most commonly used is ray tracing. Although very good at producing realistic images, this technique requires the use of powerful graphics processors and is not possible in a context such as an internet browser where processing capacity may be very limited. As a result, previous attempts to model complex three-dimensional objects such as liquids in glass bottles on internet browsers have left the resulting images appearing unsatisfactory, particularly when the user interacts with the model to rotate the object to view it from different angles. In this case, the internal refractions and reflections appear unrealistic and significantly detract from the representation of the object. This is particularly unsatisfactory for online retailers of expensive items such as perfumes and alcoholic liquors.

There is therefore a need to improve the modelling of complex three-dimensional objects which are formed from a combination of opaque and non-opaque elements.

Preferred embodiments of the present invention seek to overcome or alleviate the above described disadvantages of the prior art.

### SUMMARY OF THE INVENTION

Exemplary embodiments according to the present disclosure are directed to a method of rendering a three-dimensional representation of an object in an internet browser on a display device, including the steps of receiving on a first computer device object model data defining features of an object. It also includes identifying substantially opaque and substantially non-opaque parts of the object. There is a further step of generating browser image data for sending to a browser to render images representing the object on a display device including opacity data identifying the substantially opaque and substantially non-opaque parts. The browser image data is sent to a browser on a second computer device. The substantially opaque parts are rendered using rasterizing techniques from the browser image data and then the substantially non-opaque parts are rendered using at least one of the volume rendering technique and the depth peeled screen space refraction technique from the browser image data. A first image representing the object at a first angle in is displayed an internet browser on a display device associated with the second computer device. In the event of receiving movement instructions on the second computer device a second image representing the object at a second angle is displayed in the internet browser on the display device.

According to an aspect of the present invention there is provided a method of rendering a three-dimensional representation of an object in an internet browser on a display device, comprising the steps: receiving on a first computer device object model data defining features of an object; identifying substantially opaque and substantially non-opaque parts of the object; generating browser image data for sending to a browser to render images representing the object on a display device including opacity data identifying the substantially opaque and substantially non-opaque parts; sending the browser image data to a browser on a second computer device; rendering the substantially opaque parts using rasterizing techniques from the browser image data and then rendering the substantially non-opaque parts using at least one of the volume rendering technique and the depth peeled screen space refraction technique from the browser image data; displaying a first image representing the object at a first angle in an internet browser on a display device associated with the second computer device; receiving movement instructions on the second computer device; and displaying a second image representing the object at a second angle in the internet browser on the display device.

By using volume rendering or depth peeled screen space refraction rendering techniques to render the non-opaque parts of an object, that is the transparent and translucent parts such as liquids, the advantage is provided that these parts of the objects look more realistic than is seen in the prior art for a given processing capacity. In particular, when the object is moved, the light which appears to be passing through the non-opaque parts of the object is represented in a way that is more realistic than has been previously possible in low processing capacity situations such as where an image is being displayed in a browser. As a result, three-dimensional representations of objects can be displayed and those displays manipulated on a variety of platforms for online retailers and the like. This is particularly important when encouraging customers to buy expensive items online.

In a preferred embodiment, the non-opaque rendering technique comprises running a plurality of iterations and more preferably the plurality of iterations comprises three.

In another preferred embodiment, the substantially opaque and substantially non-opaque parts are identified by a user operating a third computing device.

In a further preferred embodiment, the first computer device comprises an internet server.

In a preferred embodiment, at least some features of the object are identified by the material they are formed from and the substantially opaque and substantially non-opaque parts are identified based on their material.

According to another aspect of the present invention there is provided a method of rendering a three-dimensional representation of an object in an internet browser on a display device, comprising the steps: receiving from a first computer device browser image data on a second computer device, the browser image data for displaying on a display device associated with the second computer device using an internet browser, the browser image data enabling a browser to render images representing an object on a display device and including opacity data identifying substantially opaque and substantially non-opaque parts of the object; using the browser data to render the substantially opaque parts using rasterizing techniques from the browser image data and then rendering the substantially non-opaque parts using at least one of the volume rendering technique and the depth peeled screen space refraction technique from the browser image data; displaying a first image representing the object at a first angle in an internet browser on a display device associated with the second computer device; and displaying a second image representing the object at a second angle in the internet browser on the display device in response to movement instructions received on the second computer device.

In a preferred embodiment the non-opaque rendering technique comprises running a plurality of iterations.

In another preferred embodiment the plurality of iterations comprises three.

In a further preferred embodiment the substantially opaque and substantially non-opaque parts are identified by a user operating a third computing device.

In an additional preferred embodiment the first computer device comprises an internet server.

In a preferred embodiment at least some features of the object are identified by the material they are formed from and the substantially opaque and substantially non-opaque parts are identified based on their material.

According to another aspect of the present invention there is provided a method of rendering a three-dimensional representation of an object in an internet browser on a display device, comprising the steps: receiving on a first computer device object model data defining features of an object; identifying substantially opaque and substantially non-opaque parts of the object; generating browser image data for sending to a browser to render images representing the object on a display device including opacity data identifying the substantially opaque and substantially non-opaque parts; and sending the browser image data to a browser on a second computer device so that the second computer device can render the substantially opaque parts using rasterizing techniques from the browser image data and then rendering the substantially non-opaque parts using at least one of the volume rendering technique and the depth peeled screen space refraction technique from the browser image data, enabling the second computer device to display a first image representing the object at a first angle in an internet browser on a display device associated with the second computer device, receive movement instructions and then displaying a second image representing the object at a second angle in the internet browser on the display device.

In a preferred embodiment the non-opaque rendering technique comprises running a plurality of iterations.

In another preferred embodiment the plurality of iterations comprises three.

In a further preferred embodiment the substantially opaque and substantially non-opaque parts are identified by a user operating a third computing device.

In an additional preferred embodiment the first computer device comprises an internet server.

In a preferred embodiment at least some features of the object are identified by the material they are formed from and the substantially opaque and substantially non-opaque parts are identified based on their material.

According to another aspect of the present invention there is provided a computer program for rendering a three-dimensional representation of an object in an internet browser on a display device, comprising the steps: first computer code for receiving on a first computer device object model data defining features of an object; second computer code for identifying substantially opaque and substantially non-opaque parts of the object; third computer code for generating browser image data for sending to a browser to render images representing the object on a display device including opacity data identifying the substantially opaque and substantially non-opaque parts; fourth computer code for sending the browser image data to a browser on a second computer device; fifth computer code for rendering the substantially opaque parts using rasterizing techniques from the browser image data and then rendering the substantially non-opaque parts using at least one of the volume rendering technique and the depth peeled screen space refraction technique from the browser image data; sixth computer code for displaying a first image representing the object at a first angle in an internet browser on a display device associated with the second computer device; seventh computer code for receiving movement instructions on the second computer device; and eighth computer code for displaying a second image representing the object at a second angle in the internet browser on the display device.

In a preferred embodiment the fifth computer code the non-opaque rendering technique comprises running a plurality of iterations.

In another preferred embodiment in the fifth computer code the plurality of iterations comprises three.

In a further preferred embodiment in the third computer code the substantially opaque and substantially non-opaque parts are identified by a user operating a third computing device.

In an additional preferred embodiment the first computer device comprises an internet server.

In a preferred embodiment in the third computer code at least some features of the object are identified by the material they are formed from and the substantially opaque and substantially non-opaque parts are identified based on their material.

According to another aspect of the present invention there is provided a computer program for rendering a three-dimensional representation of an object in an internet browser on a display device, comprising the steps: first computer code for receiving from a first computer device browser image data on a second computer device, the browser image data for displaying on a display device associated with the second computer device using an internet browser, the browser image data enabling a browser to render images representing an object on a display device and including opacity data identifying substantially opaque and substantially non-opaque parts of the object; second computer code for using the browser data to render the substantially opaque parts using rasterizing techniques from the browser image data and then rendering the substantially non-opaque parts using at least one of the volume rendering technique and the depth peeled screen space refraction technique from the browser image data; third computer code for displaying a first image representing the object at a first angle in an internet browser on a display device associated with the second computer device; and fourth computer code for displaying a second image representing the object at a second angle in the internet browser on the display device in response to movement instructions received on the second computer device.

In a preferred embodiment in the fifth computer code the non-opaque rendering technique comprises running a plurality of iterations.

In another preferred embodiment in the fifth computer code the plurality of iterations comprises three.

In a further preferred embodiment in the third computer code the substantially opaque and substantially non-opaque parts are identified by a user operating a third computing device.

In an additional preferred embodiment the first computer device comprises an internet server.

In a preferred embodiment in the third computer code at least some features of the object are identified by the material they are formed from and the substantially opaque and substantially non-opaque parts are identified based on their material.

According to another aspect of the present invention there is provided a computer program for rendering a three-dimensional representation of an object in an internet browser on a display device, comprising the steps: receiving on a first computer device object model data defining features of an object; identifying substantially opaque and substantially non-opaque parts of the object; generating browser image data for sending to a browser to render images representing the object on a display device including opacity data identifying the substantially opaque and substantially non-opaque parts; and sending the browser image data to a browser on a second computer device so that the second computer device can render the substantially opaque parts using rasterizing techniques from the browser image data and then rendering the substantially non-opaque parts using at least one of the volume rendering technique and the depth peeled screen space refraction technique from the browser image data, enabling the second computer device to display a first image representing the object at a first angle in an internet browser on a display device associated with the second computer device, receive movement instructions and then displaying a second image representing the object at a second angle in the internet browser on the display device.

In a preferred embodiment in the fifth computer code the non-opaque rendering technique comprises running a plurality of iterations.

In another preferred embodiment in the fifth computer code the plurality of iterations comprises three.

In a further preferred embodiment in the third computer code the substantially opaque and substantially non-opaque parts are identified by a user operating a third computing device.

In an additional preferred embodiment the first computer device comprises an internet server.

In a preferred embodiment in the third computer code at least some features of the object are identified by the material they are formed from and the substantially opaque and substantially non-opaque parts are identified based on their material.

### BRIEF DESCRIPTION OF THE DRAWINGS

Preferred embodiments of the present invention will now be described, by way of example only, and not in any limitative sense with reference to the accompanying drawings in which:

FIG. 1 is a schematic representation of an apparatus used in the implementation of the present invention;

FIG. 2 is a flow diagram indicating the steps used in the implementation of the present invention; and

FIG. 3 is a series of examples of the images used in the implementation of the present invention.

### DETAILED DESCRIPTION OF THE INVENTION

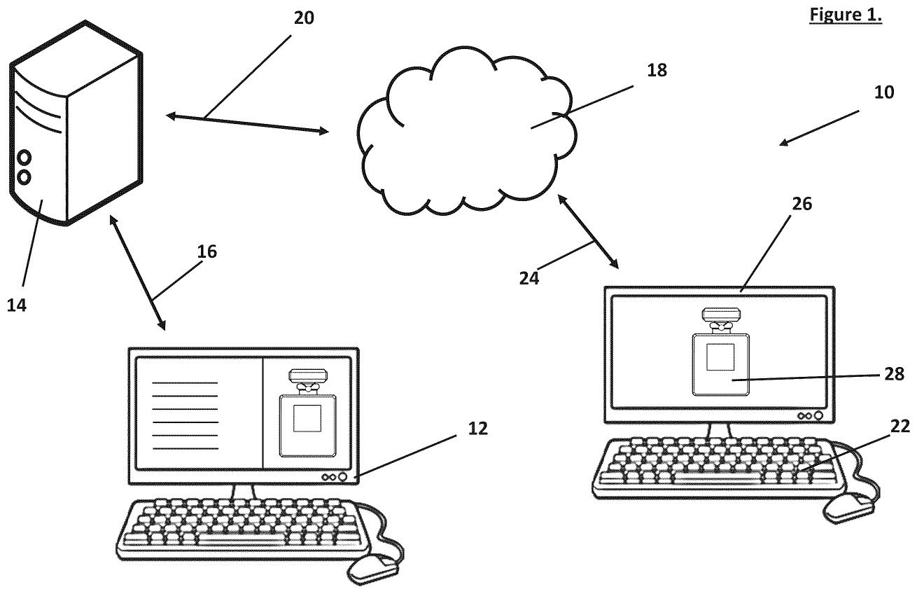

Referring initially to FIG. 1, a system 10 used in the implementation of the present invention is provided in order to render and display a three-dimensional representation of an object in an internet browser running on a display device of a computer. The system 10 includes a first computer 12 which is connected to a server 14 via a first connection 16. The server 14 is connected to the internet which is indicated at 18 by a second connection 20. A second computer device 22 is connected to the internet 18 by a connection 24. The second computer device 22 has a browser program running on it which is able to display on a display device 26 a representation of an object 28 which can be manipulated to give the user the impression of being a three-dimensional object. Examples of browsers suitable for use with the present invention include, but are not limited to, Google Chrome®, Safari®, Firefox® and Mozilla®. The browsers indicated are merely exemplary and any other suitable tool with the capacity accessing and interacting with the internet could be used.

The skilled person will be aware that the above configuration of computer devices and servers is merely an example of an arrangement of these devices to operate as a suitable system used in the implementation of the present invention. For example, the first computer device 12 may be connected to the server 14 via the internet 18. The computer devices indicated are merely exemplary and any other suitable display device with an output display and input means could be used. Examples of such computer devices include, but are not limited to, tablet computers, laptop computers, virtual reality headsets and mobile telephone devices.

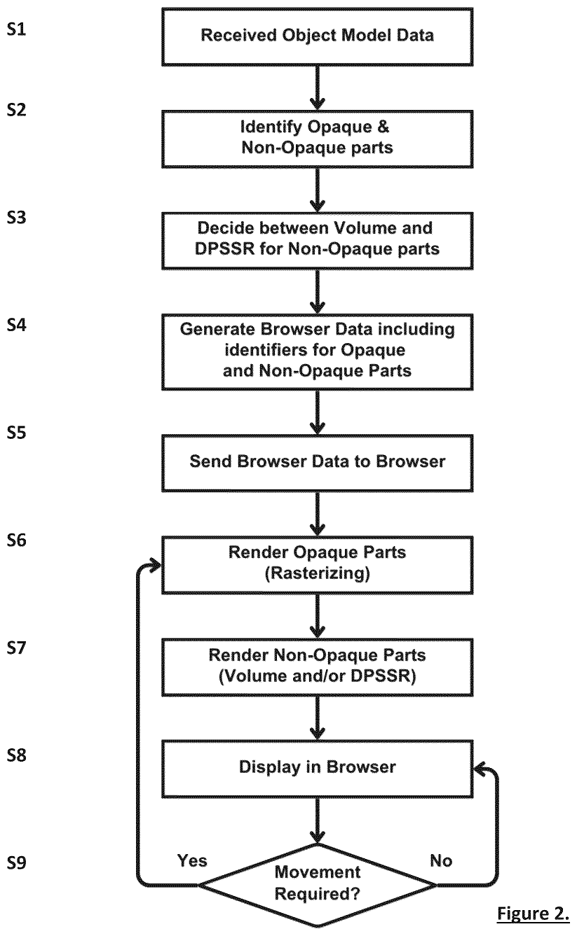

With additional reference to FIG. 2, the process of the present invention can be considered to be divided into two parts. There is an initial setup process in which data is acquired and processed in preparation for storage. These steps are identified as S1 to S4 in FIG. 2. The second part is the transfer and utilisation of that data to enable the display of the representation of the three-dimensional object on the second computer device 22. These steps are identified as S5 to S9 in FIG. 2.

Since the purpose of the invention is to display a realistic representation of a three-dimensional object data is initially required which defines the object. This is most typically a CAD file, a data file produced on a Computer Aided Design (CAD) program and typically generated as part of the design process of a product. This CAD data is received on the first computer device 12 and is converted into a suitable format for processing into a rendered image in a browser (step S1). The data is received in, for example, FBX or GLB file formats and is parsed into a JSON solution definition. The resulting file defines features of the object in three-dimensional space.

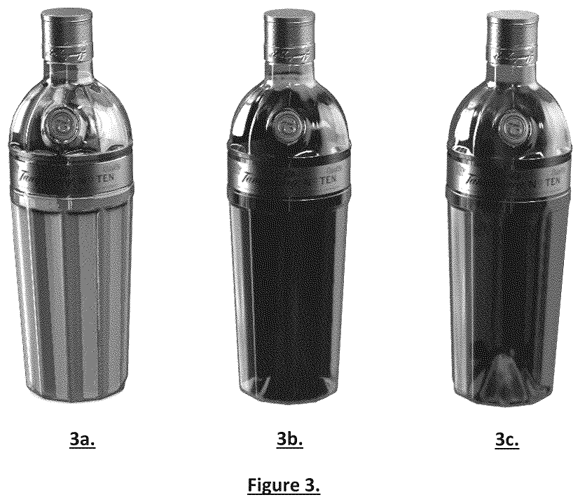

Different parts of the original object, on which the three-dimensional image is based, are formed from different materials which include some materials which are opaque and some materials which are non-opaque. The non-opaque features can be either transparent or translucent and include components made from glass, liquids, plastics and the like. These non-opaque features allow some light to pass through them, they can be coloured and they can be cloudy or non-cloudy. A typical example of such an object is shown in FIG. 3 and is a glass bottle containing a coloured transparent liquid such as whiskey. Similarly, in the schematic representation of the invention in FIG. 1 a bottle containing perfume, labelled 28, is shown. The opaque and non-opaque parts of the object are identified and a decision is made by the operator of the first computer device as to the best technique that should be used to render the representation of those features. The data equating to those parts is tagged within the data file with a tag equating to the rendering technique chosen. The tagging of the data therefore generates opacity data which forms part of the browser data. For the non-opaque parts the choice of rendering technique is between volume rendering and depth peeled screen space refraction (DPSSR). As a result, the parts of the original object are different meshes in the image and the different material of those parts are rendered using different shaders to generate the final image.

The choice between volume rendering and DPSSR rendering shader is at the discretion of the operator and may be made on a trial and error basis of determining which technique produces the more realistic result for the particular object being displayed, in particular when the object is being manipulated and moved on screen.

The volume rendering technique is able to accurately represent liquids by applying multiple reflections and refractions through the volume as it is aware of the object structure through the volume data and as a result can approximate a proper calculation of those reflections and refractions on the inside of the object without resorting to a process of heavy technique such as ray tracing. It also accepts environment data from behind the object so it can approximate outgoing reflections on the back of the object such as labels on the bottle and the scene environment behind. The accuracy of the rendering depends on the number of reflections and refractions. However, it is not intended for use in more complex environments where there are multiple opaque objects. As a result, the technique of the present invention is best suited to a scene where a single object is being manipulated and is the intended focus of attention in the scene.

The DPSSR rendering technique undertakes two renders containing front and back of the three-dimensional object. The DPSSR shader accepts those two boundaries as inputs with incoming reflections and refractions being calculated using the front depth texture and outgoing reflection and refractions from the rear surface. The DPSSR rendering technique is more suitable for complex three-dimensional objects with more pronounced details for example, complicated curved structures.

The rendering of the non-opaque parts may benefit from running a plurality of iterations of the chosen technique. Typically, three iterations represent a good balance between generating a realistic image and not using too much processing capacity on the second computing device 22, this is particularly the case for the volume rendering shader.

The imaged data file, together with the rendering type tag, forms browser data, that is data suitable for transferring to the second computer 22 and displaying in a canvas on a browser. This browser data is transferred from the first computer 12 to the server 14 via the connection 16. When an operator of the second computer 22 accesses a webpage containing script for viewing the image of the object, the browser data is sent to the browser running on the second computer (step S5). The browser data is then used to generate the image 28 of the object and display it in a canvas on the browser on the display screen 26. This is achieved by initially rendering the opaque part of the object using the well-known rasterizing technique (step S6). The non-opaque parts are then rendered using the required technique as previously selected and specified in the tag associated with the browser data for that part (step S7). Once the rendering process is complete the generated image is displayed on the canvas in the browser on the display device 26 of the second computer device 22 (step S8).

While the image remains static there is no need to re-render the image, although the display can be updated multiple times per second as represented with the “No” loop between steps S8 and S9. However, when a movement instruction is received then the new orientation of the object is determined and the image of the object re-rendered, represented with the “Yes” loop between steps S9 and S6. As a result, the opaque parts are re-rendered (step S6) followed by the non-opaque parts (step S7) and the resultant image displayed in the browser (step S8). The monitoring for a movement request (step S9) continues in a loop. The movement instruction can be from any source including, but not limited to, from a user interaction via a user interface such as a computer mouse or by instruction from a computer device simply instructing the browser to rotate the object around a particular axis.

Turning to FIG. 3, the images shown therein illustrate three different techniques used for rendering an object, in this instance a bottle of alcoholic spirits. FIG. 3a shows an image generated using only a rasterizing technique which therefore does not form part of the present invention. FIG. 3b is an example of using the volume rendering technique and FIG. 3c is an example using the DPSSR rendering technique. It can be seen that FIG. 3a does not accurately represent the refractions of light that take place within a bottle containing a liquid whereas 3b and 3c show some of the internal features of the bottle. These images are merely illustrative and do not do justice to the invention since they are reproduced here as static images and in black and white. The main benefit of the present invention is to produce a three-dimensional representation of an object displayed on a two-dimensional screen which appears to accurately represent an object containing non-opaque features when it is moved and manipulated to view from different viewing angles.

It will be appreciated by persons skilled in the art that the above embodiments have been described by way of example only and not in any limitative sense, and that various alterations and modifications are possible without departure from the scope of the protection which is defined by the appended claims. The preceding examples are a non-exhaustive list of suitable techniques and others are available which may be selected at the discretion of the person skilled in the art. In particular, where various embodiments and aspects of the invention have been described above, features and steps of the apparatus and method are interchangeable between the embodiments and aspects of the invention. For example, where dimensions are indicated in the examples set out above these are examples of ideal measurements but should not be taken as being indicative of being essential to the performance of the invention. For example, in the above embodiment the features of the object to be displayed are identified as being opaque and non-opaque by user interaction and selection of the features. However, that selection may be automatic where additional data is provided within the original data used to generate the browser image data. For example, the original CAD data might include data which indicates the material from which a feature of an object is formed and this material data can be used. Materials identified as being glass or transparent plastics or transparent liquids can then be immediately identified as being non-opaque and tagged as the opacity data forming part of the browser image data. Furthermore, the material may also be identified automatically using image recognition software which is able to determine the material of the original object on which the image is based and select the shader to be used accordingly. Typically, this is done using libraries of images containing known materials.

What is claimed is:

1. A method of rendering a three-dimensional representation of an object in an internet browser on a display device, comprising the steps:
receiving on a first computer device object model data defining features of an object;
identifying substantially opaque and substantially non-opaque parts of the object;
generating browser image data for sending to a browser to render images representing the object on a display device including opacity data identifying the substantially opaque and substantially non-opaque parts;
sending the browser image data to a browser on a second computer device;
rendering the substantially opaque parts using rasterizing techniques from the browser image data and then rendering the substantially non-opaque parts using at least one of the volume rendering technique and the depth peeled screen space refraction technique from the browser image data;
displaying a first image representing the object at a first angle in an internet browser on a display device associated with the second computer device;
receiving movement instructions on the second computer device; and
displaying a second image representing the object at a second angle in the internet browser on the display device.

2. The method according to claim 1, wherein the non-opaque rendering technique comprises running a plurality of iterations.

3. The method according to claim 2, wherein the plurality of iterations comprises three.

4. The method according to claim 1, wherein the substantially opaque and substantially non-opaque parts are identified by a user operating a third computing device.

5. The method according to claim 1, wherein the first computer device comprises an internet server.

6. The method according to claim 1, wherein at least some features of the object are identified by the material they are formed from and the substantially opaque and substantially non-opaque parts are identified based on their material.

7. A method of rendering a three-dimensional representation of an object in an internet browser on a display device, comprising the steps:
receiving from a first computer device browser image data on a second computer device, the browser image data for displaying on a display device associated with the second computer device using an internet browser, the browser image data enabling a browser to render images representing an object on a display device and including opacity data identifying substantially opaque and substantially non-opaque parts of the object;
using the browser data to render the substantially opaque parts using rasterizing techniques from the browser image data and then rendering the substantially non-opaque parts using at least one of the volume rendering technique and the depth peeled screen space refraction technique from the browser image data;
displaying a first image representing the object at a first angle in an internet browser on a display device associated with the second computer device; and
displaying a second image representing the object at a second angle in the internet browser on the display device in response to movement instructions received on the second computer device.

8. The method according to claim 7, wherein the non-opaque rendering technique comprises running a plurality of iterations.

9. The method according to claim 8, wherein the plurality of iterations comprises three.

10. The method according to claims 7, wherein the substantially opaque and substantially non-opaque parts are identified by a user operating a third computing device.

11. The method according to claims 7, wherein the first computer device comprises an internet server.

12. The method according to claim 7, wherein at least some features of the object are identified by the material they are formed from and the substantially opaque and substantially non-opaque parts are identified based on their material.

13. A computer program for rendering a three-dimensional representation of an object in an internet browser on a display device, comprising the steps:
first computer code for receiving from a first computer device browser image data on a second computer device, the browser image data for displaying on a display device associated with the second computer device using an internet browser, the browser image data enabling a browser to render images representing an object on a display device and including opacity data identifying substantially opaque and substantially non-opaque parts of the object;
second computer code for using the browser data to render the substantially opaque parts using rasterizing techniques from the browser image data and then rendering the substantially non-opaque parts using at least one of the volume rendering technique and the depth peeled screen space refraction technique from the browser image data;
third computer code for displaying a first image representing the object at a first angle in an internet browser on a display device associated with the second computer device; and
fourth computer code for displaying a second image representing the object at a second angle in the internet browser on the display device in response to movement instructions received on the second computer device.

14. The computer program according to claim 13, wherein in the fifth computer code the non-opaque rendering technique comprises running a plurality of iterations.

15. The computer program according to claim 14, wherein in the fifth computer code the plurality of iterations comprises three.

16. The computer program according to claim 13, wherein in the third computer code the substantially opaque and substantially non-opaque parts are identified by a user operating a third computing device.

17. The computer program according to claim 13, wherein the first computer device comprises an internet server.

18. The computer program according to claim 13, wherein in the third computer code at least some features of the object are identified by the material they are formed from and the substantially opaque and substantially non-opaque parts are identified based on their material.
